(19) United States
(12) Patent Application Publication
(10) Pub. No.: US 2012/0269165 A1
(43) Pub. Date: Oct. 25, 2012

(54) Apparatus and Method for Implementing One or More Handover Prioritizing Schemes

(75) Inventors: Tom Chin, San Diego, CA (US); Guangming Shi, San Diego, CA (US); Kuo-Chun Lee, San Diego, CA (US)

(73) Assignee: QUALCOMM Incorporated, San Diego, CA (US)

(21) Appl. No.: 13/384,171

(22) PCT Filed: May 7, 2010
(86) PCT No.: PCT/US10/34049

§ 371 Date: Jan. 13, 2012

Related U.S. Application Data
(60) Provisional application No. 61/258,502, filed on Nov. 5, 2009.

(51) Int. Cl. H04W 36/00

(52) U.S. Cl. 370/331

(57) ABSTRACT

Avoiding collisions when executing Handover or initial access (Random access requests) due to the use of the same synchronisation code, SYNC-UL code, at the same Uplink pilot channel, UpPCH, in the same Uplink pilot Time Slot, Up-PTS, in a TD-SCDMA system. The method may comprise receiving a signal that identifies N subframes of a subframe cycle including M subframes, wherein an uplink pilot channel in each of said N identified subframes is available for initial access and a hard handover, wherein N and M are positive integers, and wherein N is less than M. Further, the method may comprise receiving a signal that identifies G synchronization codes among H available synchronization codes, wherein each of said G identified synchronization codes is available for initial access only, wherein G and H are positive integers, and wherein G is less than H.

### CROSS-REFERENCE TO RELATED APPLICATION(S)

This application claims the benefit of U.S. Provisional Patent Application No. 61/258,502, entitled “APPARATUS AND METHOD FOR IMPLEMENTING ONE OR MORE HANDOVER PRIORITIZING SCHEMES IN TD-SCDMA SYSTEMS,” filed on Nov. 5, 2009, which is expressly incorporated by reference herein in its entirety.

### BACKGROUND

1. Field

Aspects of the present disclosure relate generally to wireless communication systems, and more particularly, to facilitate uplink (UL) synchronization during handover in TD-SCDMA systems.

2. Background

Wireless communication networks are widely deployed to provide various communication services such as telephony, video, data, messaging, broadcasts, and so on. Such networks, which are usually multiple access networks, support communications for multiple users by sharing the available network resources. One example of such a network is the Universal Terrestrial Radio Access Network (UTRAN). The UTRAN is the radio access network (RAN) defined as a part of the Universal Mobile Telecommunications System (UMTS), a third generation (3G) mobile phone technology supported by the 3rd Generation Partnership Project (3GPP). The UMTS, which is the successor to Global System for Mobile Communications (GSM) technologies, currently supports various air interface standards, such as Wideband-Code Division Multiple Access (W-CDMA), Time Division-Code Division Multiple Access (TD-CDMA), and Time Division-Synchronous Code Division Multiple Access (TD-SCDMA). For example, China is pursuing TD-SCDMA as the underlying air interface in the UTRAN architecture with its existing GSM infrastructure as the core network. The UMTS also supports enhanced 3G data communications protocols, such as High Speed Downlink Packet Data (HSDPA), which provides higher data transfer speeds and capacity to associate UMTS networks.

As the demand for mobile broadband access continues to increase, research and development continue to advance the UMTS technologies not only to meet the growing demand for mobile broadband access, but to advance and enhance the user experience with mobile communications.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method includes receiving a signal that identifies N subframes of a subframe cycle including M subframes, wherein an uplink pilot channel in each of said N identified subframes is available for initial access and a hard handover, wherein N and M are positive integers, and wherein N is less than M.

In an aspect of the disclosure, an apparatus includes means for receiving a signal that identifies N subframes of a subframe cycle including M subframes, wherein an uplink pilot channel in each of said N identified subframes is available for initial access and a hard handover, wherein N and M are positive integers, and wherein N is less than M, and means for transmitting a response using at least one of the M subframes.

In an aspect of the disclosure, a computer program product includes a computer-readable medium which includes code for receiving a signal that identifies N subframes of a subframe cycle including M subframes, wherein an uplink pilot channel in each of said N identified subframes is available for initial access and a hard handover, wherein N and M are positive integers, and wherein N is less than M.

In an aspect of the disclosure, an apparatus includes at least one processor, and a memory coupled to the at least one processor. In such an aspect, the at least one processor may be configured to receive a signal that identifies N subframes of a subframe cycle including M subframes, wherein an uplink pilot channel in each of said N identified subframes is available for initial access and a hard handover, wherein N and M are positive integers, and wherein N is less than M.

In an aspect of the disclosure, a method includes receiving a signal that identifies G synchronization codes among H available synchronization codes, wherein each of said G identified synchronization codes is available for initial access only, wherein G and H are positive integers, and wherein G is less than H.

In an aspect of the disclosure, an apparatus includes means for receiving a signal that identifies G synchronization codes among H available synchronization codes, wherein each of said G identified synchronization codes is available for initial access only, wherein G and H are positive integers, and wherein G is less than H, and wherein G is less than H, and means for transmitting a response using at least one of the H subframes.

In an aspect of the disclosure, a computer program product includes a computer-readable medium which includes code for receiving a signal that identifies G synchronization codes among H available synchronization codes, wherein each of said G identified synchronization codes is available for initial access only, wherein G and H are positive integers, and wherein G is less than H.

In an aspect of the disclosure, an apparatus includes at least one processor, and a memory coupled to the at least one processor. In such an aspect, the at least one processor may be configured to receive receiving a signal that identifies G synchronization codes among H available synchronization codes, wherein each of said G identified synchronization codes is available for initial access only, wherein G and H are positive integers, and wherein G is less than H.

In an aspect of the disclosure, a method includes transmitting a first uplink pilot signal to a Node B using a first power level, determining that the first transmitted uplink pilot signal is not acknowledged by the Node B, and transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

In an aspect of the disclosure, an apparatus includes means for transmitting a first uplink pilot signal to a Node B using a first power level, means for determining that the first transmitted uplink pilot signal is not acknowledged by the Node B, and means for transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

In an aspect of the disclosure, a computer program product includes a computer-readable medium which includes code for transmitting a first uplink pilot signal to a Node B using a first power level, code for determining that the first transmitted uplink pilot signal is not acknowledged by the Node B, and code for transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

In an aspect of the disclosure, an apparatus includes at least one processor, and a memory coupled to the at least one processor. In such an aspect, the at least one processor may be configured to transmit a first uplink pilot signal to a Node B using a first power level, determine that the first transmitted uplink pilot signal is not acknowledged by the Node B, and transmit a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a Node B in communication with a user equipment (UE) in a telecommunications system.

FIG. 4A is a functional block diagram conceptually illustrating example blocks executed to implement the functional characteristics of one aspect of the present disclosure.

FIG. 4B is another functional block diagram conceptually illustrating example blocks executed to implement the functional characteristics of one aspect of the present disclosure.

FIG. 5 is still another functional block diagram conceptually illustrating example blocks executed to implement the functional characteristics of one aspect of the present disclosure.

FIG. 6 is a block diagram conceptually illustrating exemplary uplink pilot signal configuration in multiple subframes according to an aspect.

FIG. 7 is a block diagram conceptually illustrating exemplary uplink synchronization code allocations according to an aspect.

FIG. 8 is a block diagram conceptually illustrating multiple exemplary subframes with allocated handover prioritized pilot channels according to an aspect.

FIG. 9 is a block diagram of an exemplary wireless communications device for facilitating handover prioritization schemes during handover according to an aspect.

FIG. 10 is an exemplary block diagram of a handover prioritization system according to an aspect.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

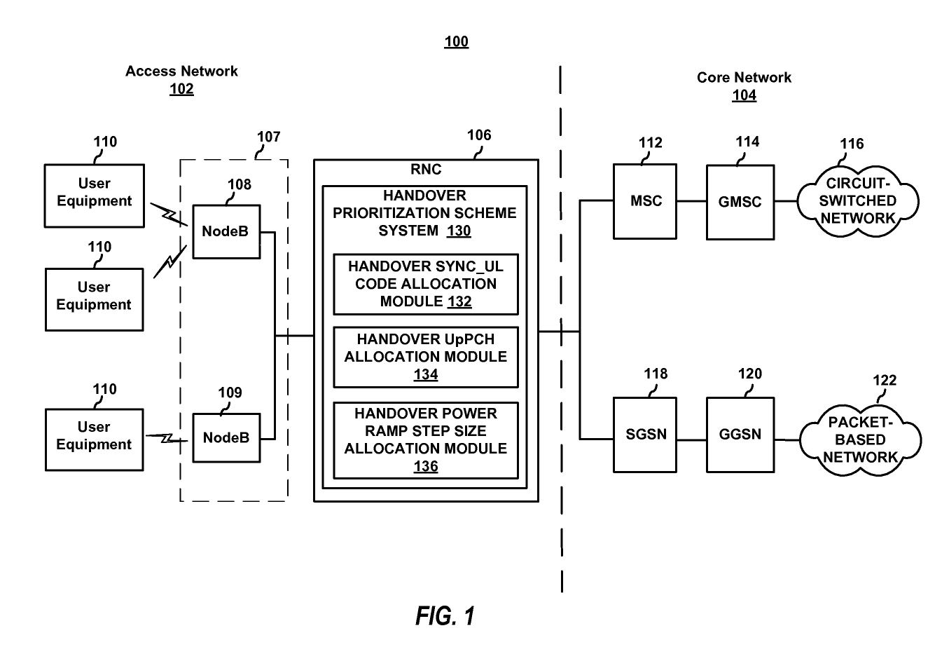

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of Radio Network Subsystems (RNSs) such as an RNS 107, each controlled by a Radio Network Controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two Node Bs 108, 109 are shown; however, the RNS 107 may include any number of wireless Node Bs. The Node Bs 108, 109 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with at least one of the Node Bs 108, 109. The downlink (DL), also called the forward link, refers to the communication link from a Node B to a UE, and the uplink (UL), also called the reverse link, refers to the communication link from a UE to a Node B.

Further, RAN 102 may include a handover prioritization scheme system 130 which may be operable to monitor, coordinate and/or control the Node Bs 108, 109. In one aspect, handover prioritization scheme system 130 may be included within RNC 106, one or more servers, etc.

In one aspect, handover prioritization scheme system 130 may further include handover synchronization uplink (SYNC_UL) code allocation module 132, handover uplink pilot channel (UpPCH) allocation module 134, and handover power ramp step size allocation module 136. In one such aspect of the system, SYNC_UL code allocation module 132 may be operable to use defined synchronization codes (e.g., SYNC_UL codes) for UEs during handover. In another aspect of the system, handover uplink pilot channel allocation module 134 may be operable to allocate UpPCH subframes from subframe cycle for UEs performing handover. In still another aspect of the system, handover power ramp step size allocation module 136 may be operable to assign larger power ramp step sizes for handover than for initial random access. In such an aspect, available step size may be 0, 1, 2, 3 dB. Therefore, if there were collision, a UE performing handover may have a larger power ramp up than a UE performing an initial random access. As such, a UE performing a handover may have an advantage in transmission power and interference.

In operation, in one aspect, a UE 110 may receive a signal that identifies N subframes of a subframe cycle including M subframes, wherein an uplink pilot channel in each of said N identified subframes is available for initial access and a hard handover, wherein N and M are positive integers, and wherein N is less than M. In operation, in another aspect, a UE 110 may receive a signal that identifies G synchronization codes (e.g., SYNC_UL codes) among H available synchronization codes, wherein each of said G identified synchronization codes is available for initial access only, wherein G and H are positive integers, and wherein G is less than H. Further, the UE 110 may send a selected SYNC_UL code on the UpPTS. In one aspect, the SYNC_UL code may be randomly selected, selected to indicate a UE may be performing a handover, selected to indicate a UE may be initially accessing a network, etc. A Node B 108 may receive the UEs transmitted SYNC_UL code and may reply to the UE with information such as a timing correction on the Fast Physical Access Channel (FPACH). Thereafter, if the UE 110 detects a match of transmission parameters (e.g., relative subframe number preceding ACK, and SYNC_UL code (or Signature Reference Number) used), then the UE may transmit on Physical Random Access Channel (PRACH) in initial random access procedure or transmit on Dedicated Physical Channel (DPCH) in handover.

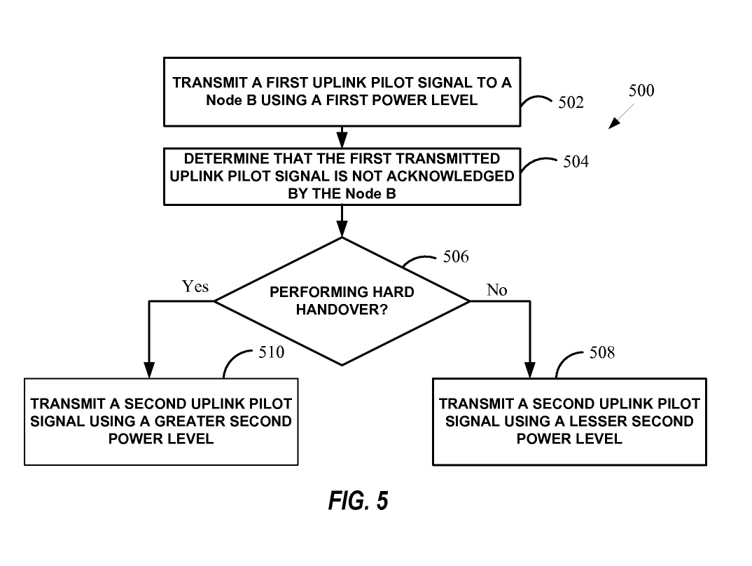

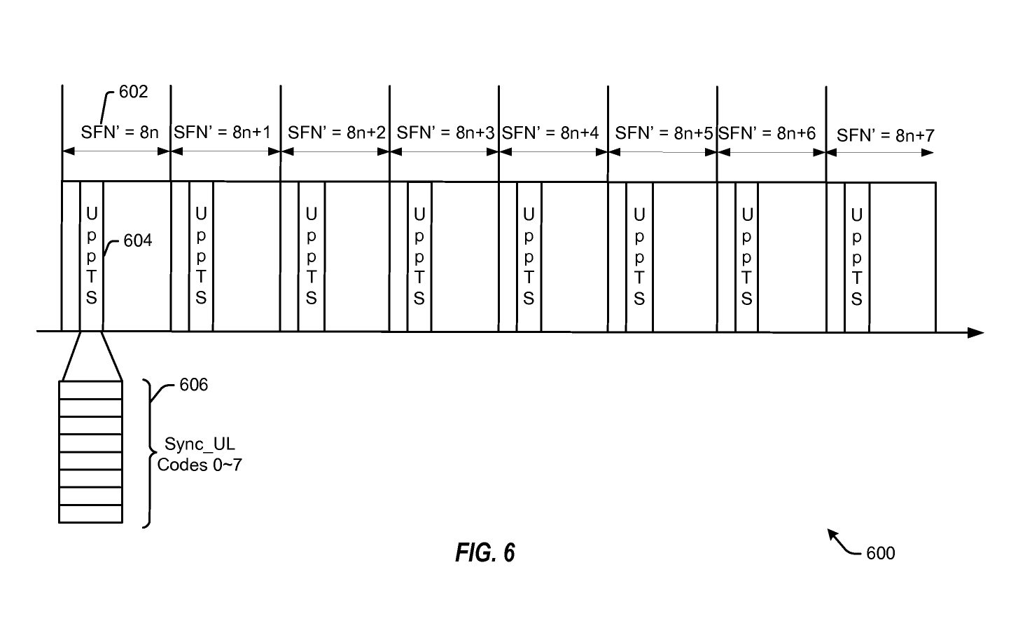

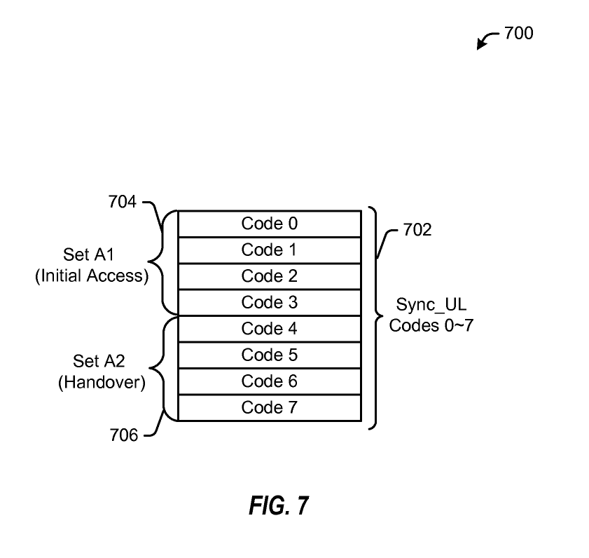

Further, the TD-SCDMA standard may define up to eight access service classes (ASC), including, but not limited to: available SYNC_UL code indices, available subframes, etc. The Available SYNC_UL codes indices ASC may indicate assigned and un-assigned SYNC_UL codes among the eight available codes. Further discussion of SYNC_UL codes is provided with reference to FIG. 6. The available subframe ASC may indicate which one of the UpPCH (Uplink Pilot Channel) in a subframe cycle may be assigned to a particular ASC. In one aspect, the assignment may indicated by an N-bitmap where N is a subchannel size (e.g., 1, 2, 4, or 8). Further discussion of subframes is provided with reference to FIGS. 5 and 7.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

In one aspect, UE 110 can further include handover uplink synchronization module that may facilitate one or more handover prioritization schemes for the UE 110. In one aspect of handover uplink synchronization module may include a system information message processing module, and a handover module. The system information message processing module may be operable to process system information messages received from one or more Node Bs. In one aspect, a broadcast from a serving Node B 108 may include a system information message with one or more information elements, such as system information block type 5, to determine which prioritization scheme to use during initial access. For example, the system information message may include one or more information elements: to determine which SYNC_UL codes may be dedicated SYNC_UL codes for initial access, to determine which subframes may be allocated for initial random access and handover, to determine an initial access power ramp step size allocation, etc.

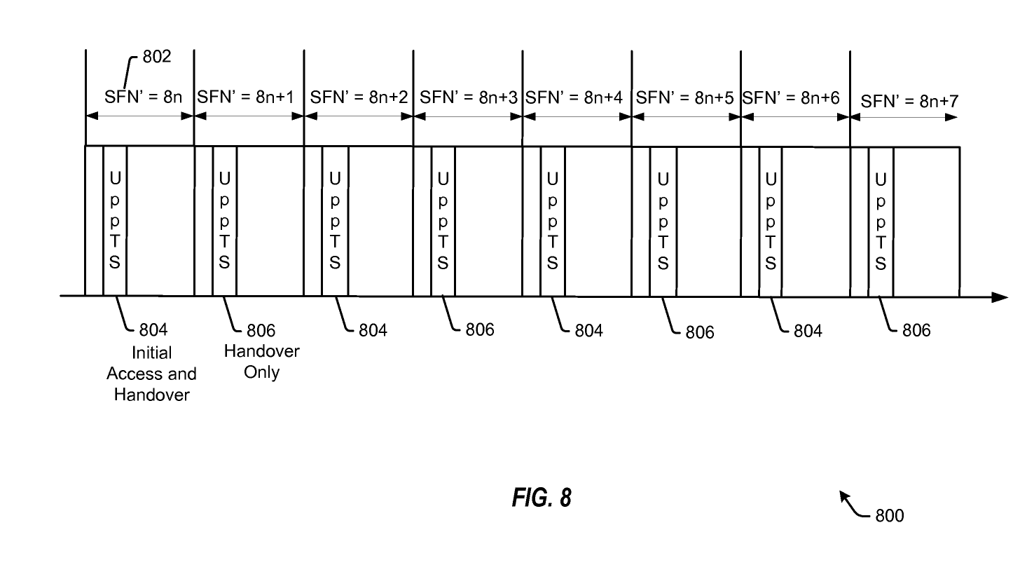

Further, the handover module may include a physical channel reconfiguration message processing module, and may be operable to process handover prioritizing scheme information received in a handover command message. In one such aspect, such information may be received from a physical channel reconfiguration message and processed using a physical channel reconfiguration message processing module. Further, the physical channel reconfiguration message may include SYNC_UL codes, bitmap allocations for: SYNC_UL codes dedicated to handover processing, UpPCHs dedicated for handover only processing, etc. The handover module may use determined uplink synchronization codes to handover to a target Node B, where the target Node B may prioritize the handover uplink synchronization higher than an initial access request so as to avoid and/or reduce call drops. An exemplary describe of a UE, such as UE 100 may be found with reference to FIG. 8.

The core network 104 also supports packet-data services with a serving GPRS support node (SGSN) 118 and a gateway GPRS support node (GGSN) 120. GPRS, which stands for General Packet Radio Service, is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a Node B 108 and a UE 110, but divides uplink and downlink transmissions into different time slots in the carrier.

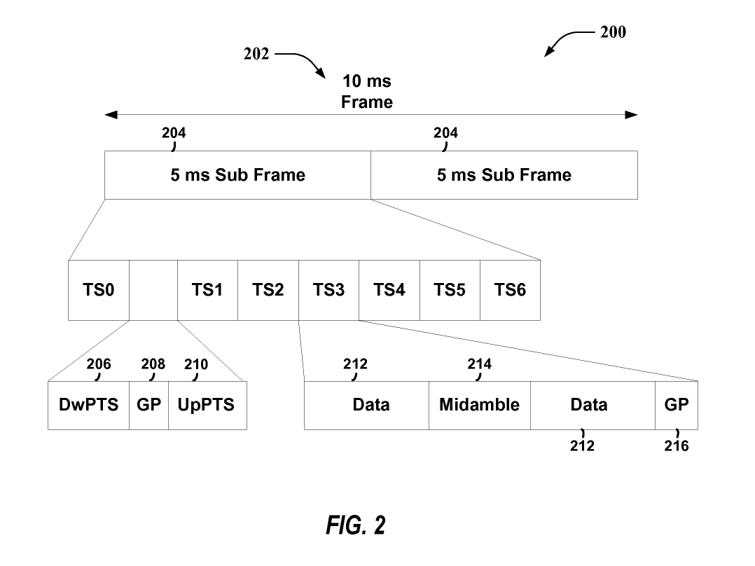

FIG. 2 shows a frame structure 200 for a TD-SCDMA carrier. The TD-SCDMA carrier, as illustrated, has a frame 202 that is 10 ms in length. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 separated by a midamble 214 and followed by a guard period (GP) 216. The midamble 214 may be used for features, such as channel estimation, while the GP 216 may be used to avoid inter-burst interference.

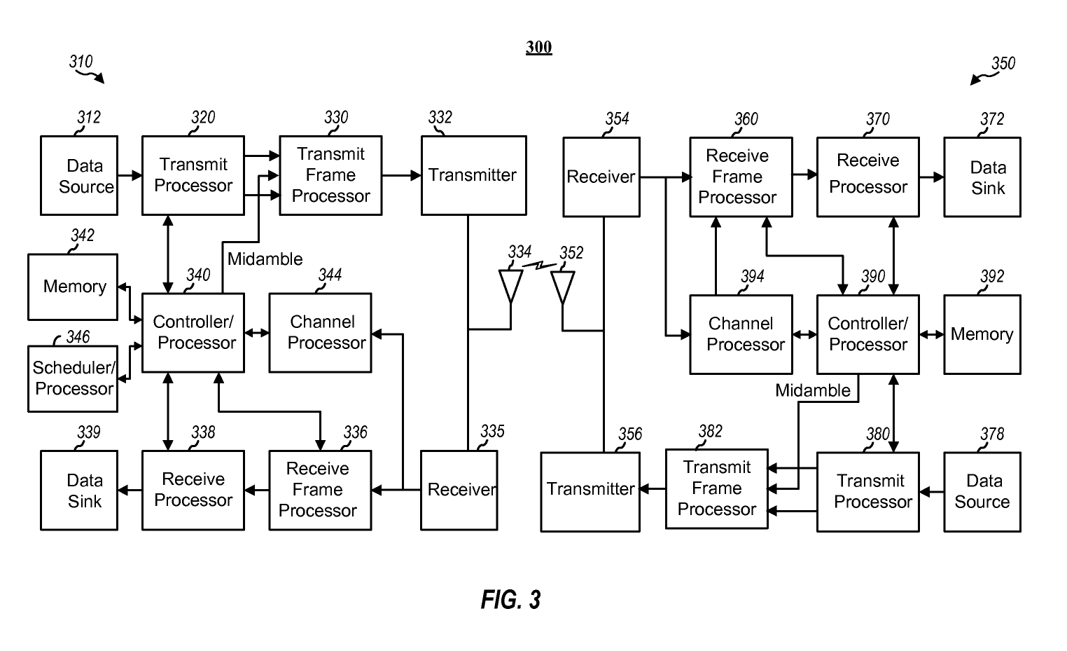

FIG. 3 is a block diagram of a Node B 310 in communication with a UE 350 in a RAN 300, where the RAN 300 may be the RAN 102 in FIG. 1, the Node B 310 may be the Node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the Node B 310. More specifically, the receive processor 370 descrambles and despreads the symbols, and then determines the most likely signal constellation points transmitted by the Node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the Node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the Node B 310 or from feedback contained in the midamble transmitted by the Node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the Node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the Node B 310 and the UE 350, respectively. For example, the controller/processors 340 and 390 may provide various functions including timing, peripheral interfaces, voltage regulation, power management, and other control functions. The computer readable media of memories 342 and 392 may store data and software for the Node B 310 and the UE 350, respectively. A scheduler/processor 346 at the Node B 310 may be used to allocate resources to the UEs and schedule downlink and/or uplink transmissions for the UEs.

In one aspect, controller/processors 340 and 390 may enable communications using a random access procedure. A random access procedure may be used for facilitating initial access and/or a hard handover. Generally, in a TD-SCDMA system, using a random access procedure, various channels and configurations may be used. For example, a random access channel (RACH) transmission time interval (TTI) may be denoted by L subframes (e.g., 1 for 5 ms, 2 for 10 ms, 4 for 20 ms), and one FPACH may correspond to N PRACHs, where N≦L. As such, the network may send an acknowledgement (ACK) on FPACH on a subframe number SFN′ mod L=0, 1 . . . N−1. One example of a general FPACH ACK is discussed with reference to Table 1.

TABLE 1
TD-SCDMA standard FPACH ACK

| Field | Length | Description |
|---|---|---|
| Signature Reference Number | 3 (MSB) | Indicate SYNC_UL |
| | | code |
| Relative Sub-Frame Number | 2 | Sub-Frame number |
| | | preceding the ACK |
| Received starting position of the | 11 | Used for timing |
| UpPCH (UpPCH_{POS}) | | correction |
| Transmit Power Level Command for | 7 | Used for transmit |
| RACH message | | power level in |
| | | PRACH |
| Reserved bits | 9 (LSB) | N/A |

Further, if the UE receives FPACH on subframe number j mod L=n, then it uses PRACH n to transmit to avoid a collision with another UE. Still further, Transmission of RACH may start two subframes following FPACH reception, but if FPACH is received on an odd subframe number and L>1, then three subframes may be needed.

In one configuration, the apparatus 350 for wireless communication includes means for transmitting a handover request and means for receiving a signal, in response to the handover request, that identifies N subframes of a subframe cycle including M subframes, wherein an uplink pilot channel in each of said N identified subframes is available for initial access and a hard handover, wherein N and M are positive integers, and wherein N is less than M. In another configuration, the apparatus 350 for wireless communication includes means for transmitting a request and means for receiving a signal, in response to the request, that identifies G synchronization codes among H available synchronization codes, wherein each of said G identified synchronization codes is available for initial access only, wherein G and H are positive integers, and wherein G is less than H. In still another configuration, the apparatus 350 for wireless communication includes means for transmitting a first uplink pilot signal to a Node B using a first power level, means for determining that the first transmitted uplink pilot signal is not acknowledged by the Node B, and means for transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y. In one aspect, the aforementioned means may be the processor(s) 390 configured to perform the functions recited by the aforementioned means. In another aspect, the aforementioned means may be a module or any apparatus configured to perform the functions recited by the aforementioned means.

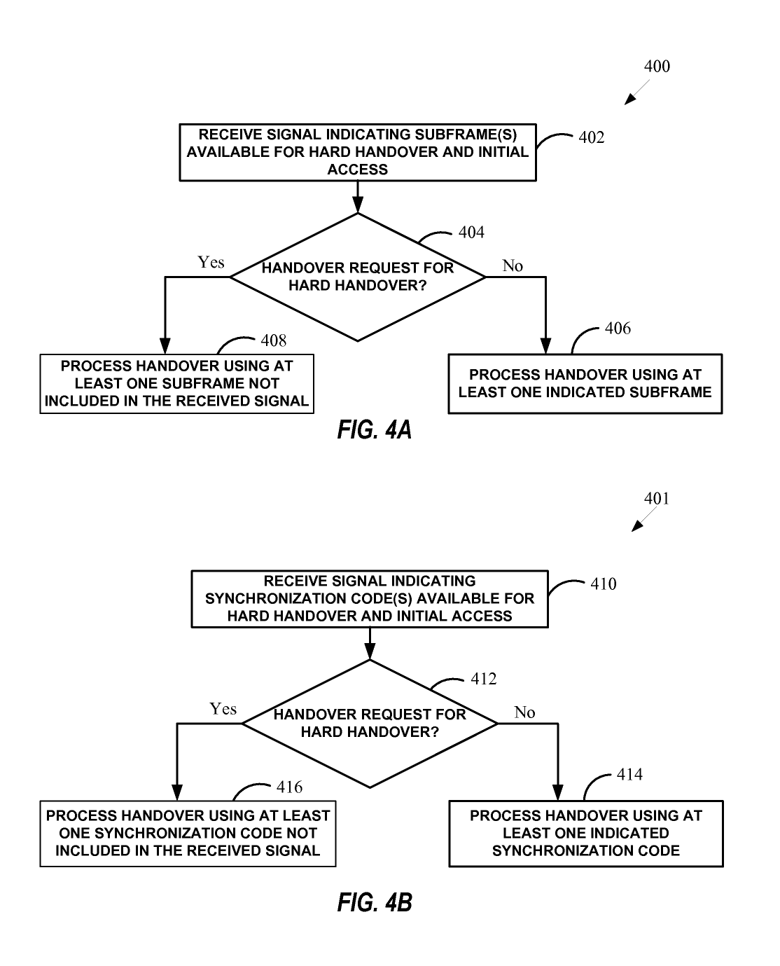

FIGS. 4A, 4B and 5 illustrate various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 4A is a functional block diagram 400 illustrating example blocks executed in conducting wireless communication according to one aspect of the present disclosure. In block 402, a UE may receive a signal indicating one or more subframes, out of a larger subframe cycle set, available for handover and initial access requests. In one aspect, the signal may include a system information message broadcast by a serving Node B. In another aspect, the signal may include an identification of which subframes may be used for hard handover. In another aspect, the signal may include receiving a power ramp up assignment, wherein the power ramp up assignment associated with the handover message assigns a greater power ramp up values than a power ramp up assignment associated with an initial access message. In block 404, it is determined whether the UE is to perform a handover or an initial access request. If in block 404, it is determined that the UE is performing an initial access request, then in block 406, the UE may perform initial access using one or more of the indicated subframes. By contrast, if in block 404, it is determined that the UE is performing hard handover, then in block 408, the UE may perform hard handover using one or more of the subframes not indicated in the signal.

FIG. 4B is another functional block diagram 401 illustrating example blocks executed in conducting wireless communication according to one aspect of the present disclosure. In block 410, a UE may receive a signal indicating one or more synchronization codes, out of a larger set synchronization codes, available for initial access requests. In one aspect, the signal may include a system information message broadcast by a serving Node B. In another aspect, the signal may include an identification of which synchronization codes may be used for hard handover. In another aspect, the signal may include receiving a power ramp up assignment, wherein the power ramp up assignment associated with the handover message assigns a greater power ramp up values than a power ramp up assignment associated with an initial access message. In block 412, it is determined whether the UE is to perform a handover or an initial access request. If in block 412, it is determined that the UE is performing an initial access request, then in block 414, the UE may perform initial access using one or more of the indicated synchronization codes. By contrast, if in block 412, it is determined that the UE is performing hard handover, then in block 416, the UE may perform hard handover using one or more of the synchronization codes not indicated in the signal.

FIG. 5 is a functional block diagram 500 illustrating example blocks executed in conducting wireless communication according to one aspect of the present disclosure. In block 502, a UE may transmit a first uplink pilot signal to a Node B using a first power level. In one aspect, the UE may perform the transmission as part of an initial access procedure, a hard handover procedure, or the like. In block 504, it is determine that the first transmitted uplink pilot signal has not been acknowledge by the targeted Node B. In one aspect, such a determination may be made after a defined period of time has lapsed. In block 506, it is determined whether the UE is transmitting to the Node B for initial access or as part of a hard handover. If, in block 506, it is determine that the UE is not performing a hard handover, then in block 508, a second uplink pilot signal is transmitted using a lesser second power level. The lesser power level may be defined in comparison to a second power level used for transmitting for a hard handover. By contrast, if in block 506 it is determined that the UE is performing a hard handover, then in block 510, then a second uplink pilot signal is transmitted using a greater second power level. The greater power level may be defined in comparison to a second power level used for transmitting for an initial access request.

Turning now to FIG. 6, a block diagram conceptually illustrating an exemplary uplink pilot signal 604 configuration in multiple subframes 602 in a system 600 is illustrated. As briefly discussed above, an available access service class (ASC) may indicate which of the Uplink Pilot Channels (UpPCHs) can be assigned to a particular ASC (e.g., a particular UE, a UpPCH for a particular function, etc.). In one aspect, the assignment may indicated by an N-bitmap where N is the subchannel size (e.g., 1, 2, 4, or 8). For example, as depicted in FIG. 6, if bit i in the N-bitmap is 1 (e.g., assigned), then the UpPTS in the system subframe number j mod N=i may be assigned to this ASC. Again, as depicted in FIG. 6, with a subchannel size=8, and with a 8-bitmap=01010101 (where the most significant bit (MSB) is bit 7 and the least significant bit (LSB) is bit 0). In such an example, the UpPCH subchannels 0, 2, 4, 6 may be assigned to a first ASC. The 8-bitmap values 606 may equate to subframe numbers, 8*n, 8*n+2, 8*n+4, 8*n+6 being assigned to the first ASC. A UE may obtain ASC settings from a system information message information element, such as system information block type 5, to determine which UpPCH may be used and/or assigned.

In operation, in handover, a UE may receive a physical channel reconfiguration message that can indicate at least one of: SYNC_UL code bitmaps, FPACH information, available subchannels, etc. Further, this physical channel reconfiguration message may specify other parameters for UL synchronization, such as maximum SYNC_UL transmissions, power ramp step increasing the SYNC_UL code transmission power upon failure, etc. Also, in one aspect of the system, if the UE does not receive the FPACH ACK, then the UE can retransmit in the following subframe and does not need to wait for a random delay as in initial random access procedure. As UL synchronization in handover may be more time critical and may demand higher reliability. As such UL synchronization for handover may be processed with a higher priority than for initial access.

Turning now to FIG. 7, a block diagram conceptually illustrating exemplary uplink synchronization code allocations in a system 700 is illustrated. Generally, as noted above, available synchronization code (e.g., SYNC_UL) indices ASC may indicate assigned and un-assigned synchronization codes 702 among available codes (e.g., eight codes). In one aspect, a Node B may allocate some dedicated synchronization codes 706 for handover and remaining synchronization codes 704 for initial access.

In operation, a Node B may broadcast a system information message assigning which synchronization codes 704 may be used for initial access. Thereafter, a UE may obtain ASC settings from the system information message information element, such as system information block type 5, to determine which synchronization codes may be dedicated synchronization codes 704 for initial access. During handover, when a Node B provides a message to command a UE to handover, such as a physical channel reconfiguration message, a synchronization codes bitmap can assign synchronization codes from the dedicated synchronization codes 706 for handover. Additionally, the dedicated synchronization codes 706 for handover and the remaining synchronization codes 704 may be disjointed and their union may be all the available synchronization codes.

As such, even before the target Node B can receive synchronization code transmissions, the target Node B may recognize synchronization codes indicating a handover compared to synchronization codes for initial access. Accordingly, the target Node B may prioritize responding to the handover synchronization codes higher than the initial access synchronization codes, and may therefore send FPACH ACKs to handover indicated codes more efficiently.

Turning now to FIG. 8, a block diagram conceptually illustrating multiple exemplary subframes 802 with allocated handover prioritized pilot channels 806 in a system 800 is illustrated. Generally, as noted above, an available access service class (ASC) may indicate which one of the UpPCHs (Uplink Pilot Channel) can be assigned to a particular ASC (e.g., a particular UE, a UpPCH for a particular function, etc.). In one aspect of the system, a Node B may allocate some UpPCH subframes of a subframe cycle to both initial access procedures and handovers 804 and some UpPCH subframes of the subframe cycle to handovers only 806. In such an aspect, the Node B may broadcast a system information message allocating only part of a subframe cycle for initial random access and handover 804. Thereafter, a UE may obtain ASC settings from the system information message information element, such as system information block type 5, to determine which subframes are allocated for initial random access. During handover, when a Node B provides a message to command a UE to handover, such as a physical channel reconfiguration message, the UE may send SYNC_UL codes on non-initial access UpPCHs 806. Therefore, collisions may be reduced and the Node B can process the handover SYNC_UL codes with a higher priority. Additionally, or in the alternative, a UE may also send a SYNC_UL code on the UpPCH subchannel for the initial access and handover, however, the probably of successfully reception and processing may be lower.

In one aspect of the system, a UE may not know which subframes of a subframe cycle may be used for initial random access and which remaining subframes may be used for handover dedicated SYNC_UL codes. In such an aspect, an additional information element may be added to a handover message, such as a physical channel reconfiguration message, to specifically indicate which UpPCHs may be assigned as dedicated handover UpPCHs.

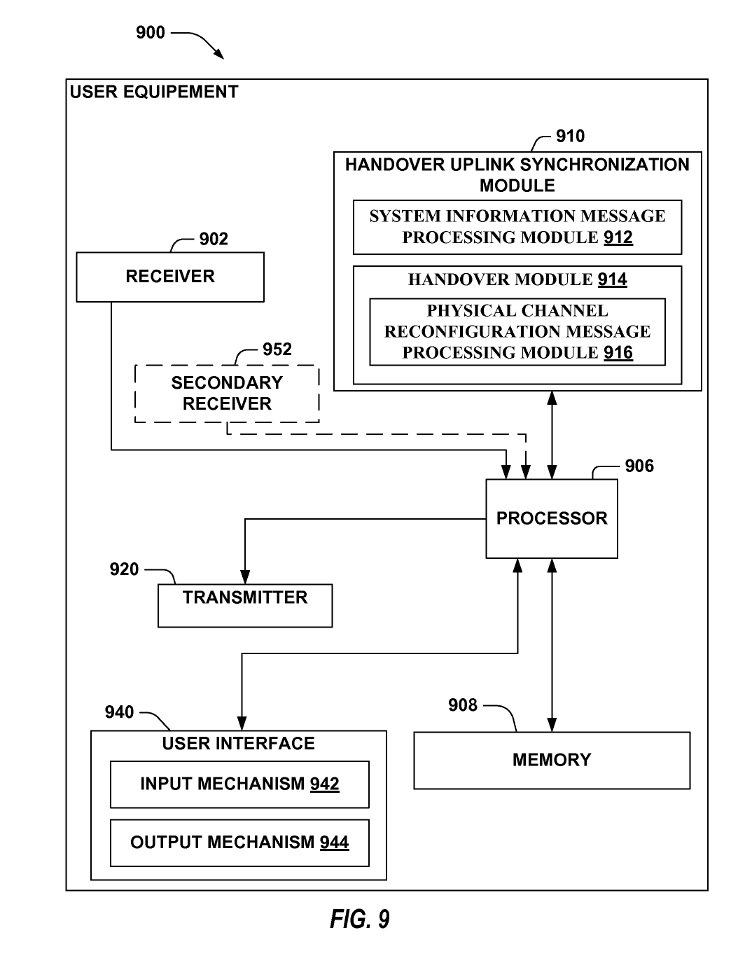

With reference now to FIG. 9, an illustration of a UE 900 (e.g., a client device, wireless communications device (WCD), etc.) that can facilitate handover triggering mechanisms using multiple metrics is presented. UE 900 comprises receiver 902 that receives one or more signal from, for instance, one or more receive antennas (not shown) performs typical actions on (e.g., filters, amplifies, downconverts, etc.) the received signal, and digitizes the conditioned signal to obtain samples. Receiver 902 can further comprise an oscillator that can provide a carrier frequency for demodulation of the received signal and a demodulator that can demodulate received symbols and provide them to processor 906 for channel estimation. In one aspect, UE 900 may further comprise secondary receiver 952 and may receive additional channels of information.

Processor 906 can be a processor dedicated to analyzing information received by receiver 902 and/or generating information for transmission by one or more transmitters 920 (for ease of illustration, only one transmitter is shown), a processor that controls one or more components of UE 900, and/or a processor that both analyzes information received by receiver 902 and/or secondary receiver 952, generates information for transmission by transmitter 920 for transmission on one or more transmitting antennas (not shown), and controls one or more components of UE 900.

In one configuration, the UE 900 includes means for transmitting a request to a Node B and means for receiving a signal, in response to the request, that identifies N subframes of a subframe cycle including M subframes, wherein an uplink pilot channel in each of said N identified subframes is available for initial access and a hard handover, wherein N and M are positive integers, and wherein N is less than M In another configuration, the UE 900 includes means for transmitting a request to a Node B and means for receiving a signal that identifies G synchronization codes among H available synchronization codes, wherein each of said G identified synchronization codes is available for initial access only, wherein G and H are positive integers, and wherein G is less than H. In still another configuration, the apparatus 900 for wireless communication includes means for transmitting a first uplink pilot signal to a Node B using a first power level, means for determining that the first transmitted uplink pilot signal is not acknowledged by the Node B, and means for transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y. In one aspect, the aforementioned means may be the processor 906 configured to perform the functions recited by the aforementioned means. In another aspect, the aforementioned means may be a module or any apparatus configured to perform the functions recited by the aforementioned means.

UE 900 can additionally comprise memory 908 that is operatively coupled to processor 906 and that can store data to be transmitted, received data, information related to available channels, data associated with analyzed signal and/or interference strength, information related to an assigned channel, power, rate, or the like, and any other suitable information for estimating a channel and communicating via the channel. Memory 908 can additionally store protocols and/or algorithms associated with estimating and/or utilizing a channel (e.g., performance based, capacity based, etc.).

It will be appreciated that the data store (e.g., memory 908) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Memory 908 of the subject systems and methods is intended to comprise, without being limited to, these and any other suitable types of memory.

UE 900 can further include handover uplink synchronization module 910 that facilitate one or more handover prioritization schemes for the UE 900. In one aspect of handover uplink synchronization module 910 may include system information message processing module 912, and handover module 914. System information message processing module 912 may be operable to process system information messages received from one or more Node Bs. In one aspect, a broadcast may include a system information message with one or more information elements, such as system information block type 5, to determine which handover prioritization scheme to use during handover. For example, the system information message may include one or more information elements: to determine which SYNC_UL codes may be dedicated SYNC_UL codes for initial access, to determine which subframes may be allocated for initial random access and handover, to determine an initial access power ramp step size allocation, etc.

Further, handover module 914 may include physical channel reconfiguration message processing module 916, and may be operable to process handover prioritizing scheme information received in a handover command message. In one such aspect, such information may be received from a physical channel reconfiguration message and processed using physical channel reconfiguration message processing module 916. Further, the physical channel reconfiguration message may include SYNC_UL codes bitmap allocations for: SYNC_UL codes dedicated to handover processing, UpPCHs dedicated for handover only processing, etc. Handover module 914 may use determined uplink synchronization codes to handover to a target Node B, where the target Node B may prioritize the handover uplink synchronization higher than an initial access request so as to avoid and/or reduce call drops.

Additionally, UE 900 may include user interface 940. User interface 940 may include input mechanisms 942 for generating inputs into UE 900, and output mechanism 944 for generating information for consumption by the user of wireless device 900. For example, input mechanism 942 may include a mechanism such as a key or keyboard, a mouse, a touch-screen display, a microphone, etc. Further, for example, output mechanism 944 may include a display, an audio speaker, a haptic feedback mechanism, a Personal Area Network (PAN) transceiver etc. In the illustrated aspects, output mechanism 944 may include a display operable to present content that is in image or video format or an audio speaker to present content that is in an audio format.

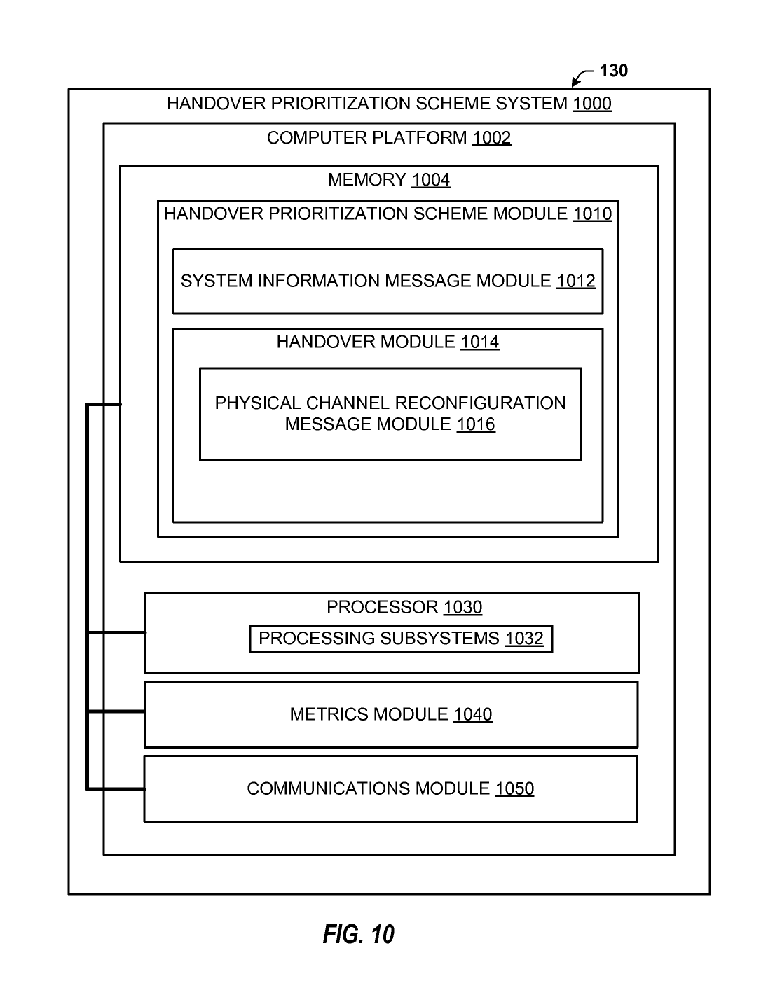

With reference to FIG. 10, illustrated is a detailed block diagram of handover prioritization scheme system 1000, such as handover prioritization scheme system 130 depicted in FIG. 1. Handover prioritization scheme system 1000 may comprise at least one of any type of hardware, server, personal computer, mini computer, mainframe computer, or any computing device either special purpose or general computing device. Further, the modules and applications described herein as being operated on or executed by handover prioritization scheme system 1000 may be executed entirely on a single network device, as shown in FIG. 10, or alternatively, in other aspects, separate servers, databases or computer devices may work in concert to provide data in usable formats to parties, and/or to provide a separate layer of control in the data flow between UEs 110, Node Bs 108, 109 and the modules and applications executed by handover prioritization scheme system 1000.

Handover prioritization scheme system 1000 includes computer platform 1002 that can transmit and receive data across wired and wireless networks, and that can execute routines and applications. Computer platform 1002 includes memory 1004, which may comprise volatile and nonvolatile memory such as read-only and/or random-access memory (ROM and RAM), EPROM, EEPROM, flash cards, or any memory common to computer platforms. Further, memory 1004 may include one or more flash memory cells, or may be any secondary or tertiary storage device, such as magnetic media, optical media, tape, or soft or hard disk. Still further, computer platform 1002 also includes processor 1030, which may be an application-specific integrated circuit (“ASIC”), or other chipset, logic circuit, or other data processing device. Processor 1030 may include various processing subsystems 1032 embodied in hardware, firmware, software, and combinations thereof, that enable the functionality of handover prioritization scheme module 1010 and the operability of the network device on a wired or wireless network.

Computer platform 1002 further includes communications module 1050 embodied in hardware, firmware, software, and combinations thereof that enables communications among the various components of handover prioritization scheme system 1000, as well as between handover prioritization scheme system 1000 and Node Bs 108, 109. Communication module 1050 may include the requisite hardware, firmware, software and/or combinations thereof for establishing a wireless communication connection. According to described aspects, communication module 1050 may include hardware, firmware and/or software to facilitate wireless broadcast, multicast and/or unicast communication of requested cell, Node B, UE, etc.

Computer platform 1002 further includes metrics module 1040, embodied in hardware, firmware, software, and combinations thereof, that enables metrics received from Node Bs 108, 109 corresponding to, among other things, data communicated from UEs 110. In one aspect, handover prioritization scheme system 1000 may analyze data received through metrics module 1040 monitor network health, capacity, usage, etc. For example, if the metrics module 1040 returns data indicating that one or more of a plurality of Node Bs are inefficient, then the handover prioritization scheme system 1000 may suggest that UEs 110 handover away from said inefficient Node B.

Memory 1004 of handover prioritization scheme system 1000 includes handover prioritization scheme module 1010 operable for assisting in network facilitated handover using prioritization schemes. In one aspect, handover prioritization scheme module 1010 may include system information message module 1012 and handover module 1014. In one aspect of the system, system information message module 1012 may be operable to generate access serving class information including configuration information associated with at least one of the one or more prioritization schemes. Such information may be broadcast to one or more UEs using a system information message with one or more information elements, such as system information block type 5, to determine which prioritization scheme to use during handover. For example, the system information message may include one or more information elements: to determine which SYNC_UL codes may be dedicated for initial access, to determine which subframes may be allocated for initial random access and handover, to determine an initial access power ramp step size allocation, etc.

Memory 1004 of handover prioritization scheme system 1000 includes handover module 1014 which may include physical channel reconfiguration message module 1016 operable for providing handover prioritization scheme information which may be transmitted to a UE performing a handover. In one aspect, such information may be transmitted using a physical channel reconfiguration message. Further, the physical channel reconfiguration message may include SYNC_UL codes bitmap allocations for: SYNC_UL codes dedicated to handover processing, UpPCHs dedicated for handover only processing, etc.

Several aspects of a telecommunications system has been presented with reference to a TD-SCDMA system. As those skilled in the art will readily appreciate, various aspects described throughout this disclosure may be extended to other telecommunication systems, network architectures and communication standards. By way of example, various aspects may be extended to other UMTS systems such as W-CDMA, High Speed Downlink Packet Access (HSDPA), High Speed Uplink Packet Access (HSUPA), High Speed Packet Access Plus (HSPA+) and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one” of a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication, comprising:
receiving a signal that identifies N subframes of a subframe cycle including M subframes, wherein an uplink pilot channel in each of said N identified subframes is available for initial access and a hard handover, wherein N and M are positive integers, and wherein N is less than M.

2. The method of claim 1, further comprising:
receiving a handover message assigning at least one of the M minus N subframes; and
performing a hard handover using the at least one of the M minus N subframes.

3. The method of claim 2, wherein the hard handover performance further comprises receiving a power ramp up assignment, wherein the power ramp up assignment associated with the handover message assigns a greater power ramp up values than a power ramp up assignment associated with an initial access message.

4. The method of claim 1, wherein the signal includes an information element that identifies the N subframes.

5. The method of claim 1, wherein the signal comprises a system information message, and wherein the system information message is broadcast by a serving Node B.

6. The method of claim 1, further comprising:
transmitting a response to a serving Node B using at least one of the M subframes.

7. The method of claim 1, wherein the wireless communication is performed in a time division synchronous code division multiple access (TD-SCDMA) system.

8. An apparatus for wireless communication, comprising:
means for receiving a signal that identifies N subframes of a subframe cycle including M subframes, wherein an uplink pilot channel in each of said N identified subframes is available for initial access and a hard handover, wherein N and M are positive integers, and wherein N is less than M; and
means for transmitting a response to a serving Node B using at least one of the M subframes.

9. The apparatus of claim 8, further comprising:
means for receiving a handover message assigning at least one of the M minus N subframes; and
means for performing a hard handover using the at least one of the M minus N subframes.

10. The apparatus of claim 9, further comprising:
wherein the hard handover performance further comprises means for receiving a power ramp up assignment, wherein the power ramp up assignment associated with the handover message assigns a greater power ramp up values than a power ramp up assignment associated with an initial access message.

11. The apparatus of claim 8, wherein the signal includes an information element that identifies the N subframes.

12. The apparatus of claim 8, wherein the signal comprises a system information message, and wherein the system information message is broadcast by a serving Node B.

13. The apparatus of claim 8, wherein wireless communication is performed in a time division synchronous code division multiple access (TD-SCDMA) system.

14. A computer program product, comprising:
a computer-readable medium comprising code for:
receiving a signal that identifies N subframes of a subframe cycle including M subframes, wherein an uplink pilot channel in each of said N identified subframes is available for initial access and a hard handover, wherein N and M are positive integers, and wherein N is less than M.

15. An apparatus for wireless communication, comprising:
at least one processor; and
a memory coupled to the at least one processor,
wherein the at least one processor is configured to:
receive a signal that identifies N subframes of a subframe cycle including M subframes, wherein an uplink pilot channel in each of said N identified subframes is available for initial access and a hard handover, wherein N and M are positive integers, and wherein N is less than M.

16. The apparatus of claim 15, wherein the at least one processor is further configured to:
receive a handover message assigning at least one of the M minus N subframes; and
perform a hard handover using the at least one of the M minus N subframes.

17. The apparatus of claim 16, wherein the at least one processor is further configured to:
receive a power ramp up assignment, wherein the power ramp up assignment associated with the handover message assigns a greater power ramp up values than a power ramp up assignment associated with an initial access message.

18. The apparatus of claim 15, wherein the signal includes an information element that identifies the N subframes.

19. The apparatus of claim 15, wherein the signal comprises a system information message, and wherein the system information message is broadcast by a serving Node B.

20. The apparatus of claim 15, wherein the at least one processor is further configured to:
transmit a response to a serving Node B using at least one of the M subframes.

21. The apparatus of claim 15, wherein the wireless communication is performed in a time division synchronous code division multiple access (TD-SCDMA) system.

22. A method of wireless communication, comprising:
receiving a signal that identifies G synchronization codes among H available synchronization codes, wherein each of said G identified synchronization codes is available for initial access only, wherein G and H are positive integers, and wherein G is less than H.

23. The method of claim 22, further comprising:
receiving a handover message assigning at least one of the H minus G synchronization codes; and
performing a hard handover using the at least one of the H minus G synchronization codes.

24. The method of claim 23, wherein the hard handover performance further comprises receiving a power ramp up assignment, wherein the power ramp up assignment associated with the handover message assigns a greater power ramp up than a power ramp up assignment associated with an initial access message.

25. The method of claim 22, wherein the signal includes an information element that identifies the G synchronization codes.

26. The method of claim 22, wherein the signal comprises a system information message, and wherein the system information message is broadcast by a serving Node B.

27. The method of claim 22, further comprising:
transmitting a response to a serving Node B using at least one of the H synchronization codes.

28. The method of claim 22, wherein the wireless communication is performed in a time division synchronous code division multiple access (TD-SCDMA) system.

29. An apparatus for wireless communication, comprising:
means for receiving a signal that identifies G synchronization codes among H available synchronization codes, wherein each of said G identified synchronization codes is available for initial access only, wherein G and H are positive integers, and wherein G is less than H; and
means for transmitting a response to a serving Node B using at least one of the H synchronization codes.

30. The apparatus of claim 29, further comprising:
means for receiving a handover message assigning at least one of the H minus G synchronization codes; and
means for performing a hard handover using the at least one of the H minus G synchronization codes.

31. The apparatus of claim 30, further comprising:
wherein the hard handover performance further comprises means for receiving a power ramp up assignment, wherein the power ramp up assignment associated with the handover message assigns a greater power ramp up value than a power ramp up assignment associated with an initial access message.

32. The apparatus of claim 29, wherein the signal includes an information element that identifies the G subframes.

33. The apparatus of claim 29, wherein the signal comprises a system information message, and wherein the system information message is broadcast by a serving Node B.

34. The apparatus of claim 29, wherein wireless communication is performed in a time division synchronous code division multiple access (TD-SCDMA) system.

35. A computer program product, comprising:
a computer-readable medium comprising code for:
receiving a signal that identifies G synchronization codes among H available synchronization codes, wherein each of said G identified synchronization codes is available for initial access only, wherein G and H are positive integers, and wherein G is less than H.

36. An apparatus for wireless communication, comprising:
at least one processor; and
a memory coupled to the at least one processor,
wherein the at least one processor is configured to:
receive a signal that identifies G synchronization codes among H available synchronization codes, wherein each of said G identified synchronization codes is available for initial access only, wherein G and H are positive integers, and wherein G is less than H.

37. The apparatus of claim 36, wherein the at least one processor is further configured to:
receive a handover message assigning at least one of the H minus G synchronization codes; and
perform a hard handover using the at least one of the H minus G synchronization codes.

38. The apparatus of claim 37, wherein the at least one processor is further configured to:
receive a power ramp up assignment, wherein the power ramp up assignment associated with the handover message assigns a greater power ramp up values than a power ramp up assignment associated with an initial access message.

39. The apparatus of claim 36, wherein the signal includes an information element that identifies the G synchronization codes.

40. The apparatus of claim 36, wherein the signal comprises a system information message, and wherein the system information message is broadcast by a serving Node B.

41. The apparatus of claim 36, wherein the at least one processor is further configured to:
transmit a response to a serving Node B using at least one of the H subframes.

42. The apparatus of claim 36, wherein the wireless communication is performed in a time division synchronous code division multiple access (TD-SCDMA) system.

43. A method of wireless communication, comprising:
transmitting a first uplink pilot signal to a Node B using a first power level;
determining that the first transmitted uplink pilot signal is not acknowledged by the Node B;
transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

44. The method of claim 43, further comprising:
receiving a handover message assigning at least one of H minus G synchronization codes, wherein each of said G synchronization codes is available for initial access only, wherein G and H are positive integers, wherein G is less than H, and wherein the handover message further includes a power ramp up assignment, wherein the power ramp up assignment defines the first power level and the second power level which is greater than the first power level by X.

45. The method of claim 43, wherein the wireless communication is performed in a time division synchronous code division multiple access (TD-SCDMA) system.

46. An apparatus for wireless communication, comprising:
means for transmitting a first uplink pilot signal to a Node B using a first power level;
means for determining that the first transmitted uplink pilot signal is not acknowledged by the Node B;
means for transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

47. The apparatus of claim 46, further comprising:
means for receiving a handover message assigning at least one of H minus G synchronization codes, wherein each of said G synchronization codes is available for initial access only, wherein G and H are positive integers, wherein G is less than H, and wherein the handover message further includes a power ramp up assignment, wherein the power ramp up assignment defines the first power level and the second power level which is greater than the first power level by X.

48. The apparatus of claim 46, wherein the wireless communication is performed in a time division synchronous code division multiple access (TD-SCDMA) system.

49. A computer program product, comprising:
a computer-readable medium comprising code for:
transmitting a first uplink pilot signal to a Node B using a first power level;
determining that the first transmitted uplink pilot signal is not acknowledged by the Node B;
transmitting a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

50. An apparatus for wireless communication, comprising:
at least one processor; and
a memory coupled to the at least one processor,
wherein the at least one processor is configured to:
transmit a first uplink pilot signal to a Node B using a first power level;
determine that the first transmitted uplink pilot signal is not acknowledged by the Node B;
transmit a second uplink pilot signal using a second power level, wherein the second power level is greater than the first power level by Y when the first and the second uplink pilot signals are used for initial access, wherein the second power level is greater than the first power level by X when the first and the second uplink pilot signals are used for a hard handover, and wherein X is greater than Y.

51. The apparatus of claim 50, wherein the at least one processor is further configured to:
receive a handover message assigning at least one of H minus G synchronization codes, wherein each of said G synchronization codes is available for initial access only, wherein G and H are positive integers, wherein G is less than H, and wherein the handover message further includes a power ramp up assignment, wherein the power ramp up assignment defines the first power level and the second power level which is greater than the first power level by X.

52. The apparatus of claim 50, wherein the wireless communication is performed in a time division synchronous code division multiple access (TD-SCDMA) system.
